(19) United States
(12) Patent Application Publication
(10) Pub. No.: US 2001/0007406 A1
(43) Pub. Date: Jul. 12, 2001

(54) Mask in color cathode ray tube

(76) Inventor: Byoung Nam Kim, Taejon-shi (KR)

Correspondence Address: BIRCH STEWART KOLASCH & BIRCH, PO BOX 747, FALLS CHURCH, VA, 22040-0747, US

(21) Appl. No.: 09/725,481

(22) Filed: Nov. 30, 2000

(30) Foreign Application Priority Data
Nov. 30, 1999 (KR) 1999-53949

(51) Int. Cl. H01J 29/80

(52) U.S. Cl. 313/402; 313/407

(57) ABSTRACT

Mask in a color cathode ray tube, including electron beam pass through holes with bridges connected to non-hole portions between the beam pass through holes in a width direction, wherein a thickness of the bridge of the mask facing an electron gun is formed thinner than other portions of the mask, thereby attenuating howling and enhancing a luminance.

### BACKGROUND OF THE INVENTION

1. Field of the Invention

The present invention relates to a color cathode ray tube, and more particularly, to a mask in a color cathode ray tube for selecting colors of electron beams.

2. Background of the Invention

Of the color cathode ray tubes, related art flat cathode ray tubes which are currently spreading widely will be explained, briefly.

Referring to FIG. 1, the related art flat color cathode ray tube is provided with a flat panel 1 of glass, and a funnel 3 in a form of a bulb welded to a back surface of the panel 1 by using Frit glass, to form an enclosure, with an inside space at a 10⁻⁷ Torr high vacuum. And, there is a safety glass 5 attached to a front surface of the panel 1 by using resin for prevention of explosion of the cathode ray tube, and R, G, B fluorescent film 2 coated on an effective area of a back surface of the panel 1 in a fixed pattern. And, there is a rail assembly 7 of rectangular metal frame bonded to a non-effective area of the panel 1 by using Frit glass, and a mask 11 welded to the rail assembly 7 having a fine beam pass through holes 10 of slit or crevice form at fixed intervals for selective passing of the R, G, B electron beams 9. And, there is an electron gun 13 sealed in a bottle neck formed neck portion 4 in a rear portion of the funnel 3 for emission of electron beams 9, and a yoke 15 on an outer circumference of the neck portion 4 for forming vertical and horizontal magnetic fields to deflect, and direct the electron beams 9 to an entire surface of the panel 1.

When a power is provided to the foregoing flat cathode ray tube through a plurality of stem pins 16 at a rear thereof, thermal electrons (electron beams) are emitted from the cathodes as a heater in the electron gun 13 is heated, controlled, accelerated and focused as the electron beams 9 pass through a plurality of electrodes in the electron gun 9 in succession, subjected to color selection as the electron beams 9 pass through the mask 11 on an electron beam travel path, and collides onto the fluorescent film 2 coated on an inside surface of the panel 1 when a picture is formed as the electron beams 9 are deflected by the yoke 15 on the outer circumference of the neck portion 4 to the screen area.

In the meantime, referring to FIGS. 2 and 3, only 20-25% of the electron beams 9 from the electron gun 13 pass through the beam pass through hole 10 in the mask 11, while approx. 75-80% is cut off at the non-hole portion 12. The electron beams 9 cut off at the mask 11 are converted into a thermal energy, to expand the mask 11 by the thermal energy, that causes doming in which path of the electron beams incident to the screen is changed, to deteriorate a color purity. Consequently, to prevent the doming of the mask 11, a tension mask is employed, wherein a strain is given to the tension mask before the tension mask is fixed to the rail assembly 7 so that the tension mask can counteract to the thermal expansion. In order to give such a strain to the tension mask, the mask 11 is required, not only an appropriate material property, but also an appropriate thickness, which is in a range of 25˜80 μm. However, even if the mask 11 has a thickness with in the above range, the mask 11 is required to be subjected to 1 or 2 times of rolling for flattening the mask 11, which delays fabrication and pushes a cost up. And, the mask 11 is liable to plastic deformation, such as crumpling, bending, or tearing off, or damage, which deteriorate a productivity. And, for fear of deformation, the mask 11 can not be subjected to washing process for removing foreign matters stuck to the mask 11, which causes defective mask 11 with the foreign matter got in the beam pass through holes 10. And, there is a problem of occurrence of howling in which the picture looks wavy as the electron beams collide, not its own color, but other color, on the screen owing to vibration of the mask 11 even by a fine external impact. As a solution for this, the thickness of the mask 11 is designed to be approx. 80 μm, an allowable maximum range of tension thickness as shown in FIG. 3. However, the above solution causes other problem. Particularly, the thicker mask 11 also forms a thicker wall of the beam pass through hole 10, that deteriorates a transmissivity of the electron beams 9. That is, as shown in FIGS. 4 and 5, if the two masks 11 are compared to be t₁<T₁, wall tapers of the beam pass through holes 10 are also compared to be t₂<T₂, and, accordingly, bridge areas formed between each beam pass through holes 10 in a width direction are also compared to be s₃<S₃ Consequently, the increased bridge surface increases a cut off amount of the electron beams 9, that reduces the transmissivity of the electron beams, and deteriorates a luminance.

### SUMMARY OF THE INVENTION

Accordingly, the present invention is directed to a mask in a color cathode ray tube that substantially obviates one or more of the problems due to limitations and disadvantages of the related art.

An object of the present invention is to provide a mask in a color cathode ray tube, in which a structure of the mask is improved for reducing howling and doming and improving a luminance.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the mask in a color cathode ray tube, including electron beam pass through holes with bridges connected to non-hole portions between the beam pass through holes in a width direction, wherein a thickness of the bridge of the mask facing an electron gun is formed thinner than other portions of the mask, thereby attenuating howling and enhancing a luminance.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a longitudinal section of a related art flat cathode ray tube;

FIG. 2 illustrates a perspective view of a related art mask;

FIG. 3 illustrates an enlarged view of ‘A’ part in FIG. 2;

FIG. 4 illustrates a section across line I-I in FIG. 3;

FIG. 5 illustrates a section of a key part of a related art thick mask;

FIG. 6 illustrates a perspective view of a key part of a mask in accordance with a preferred embodiment of the present invention; and,

FIG. 7 illustrates a section across line II-II in FIG. 6; and,

FIG. 8 illustrates a section across line III-III in FIG. 6.

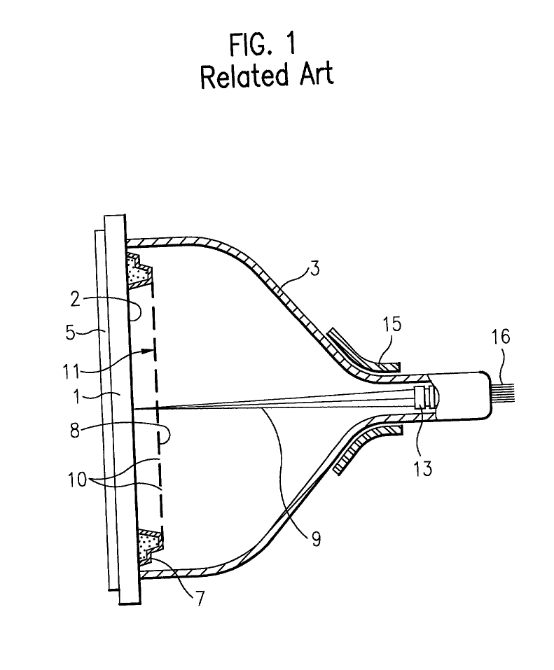

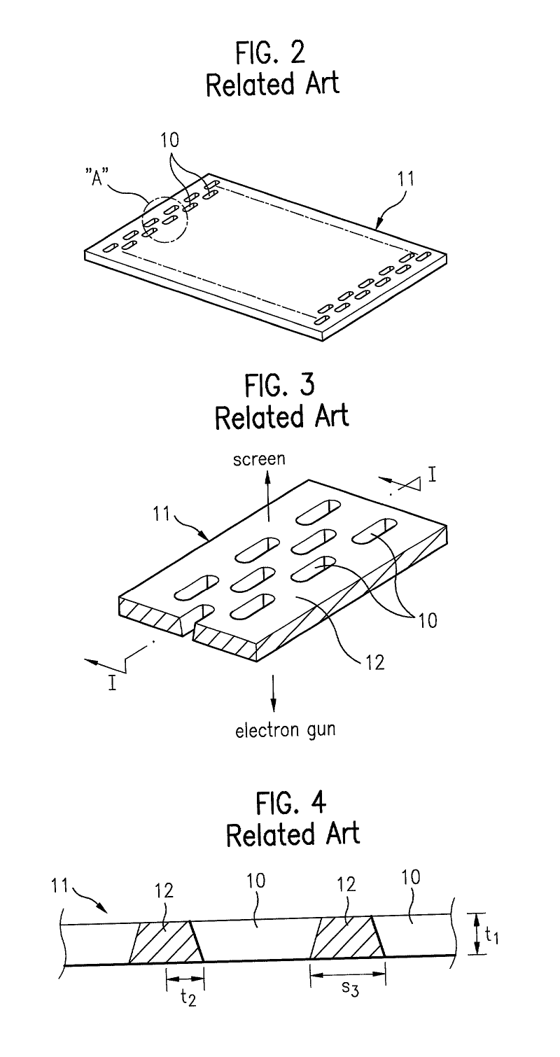

### DETAILED DESCRIPTION OF THE PREFERRED EMBODIMENT

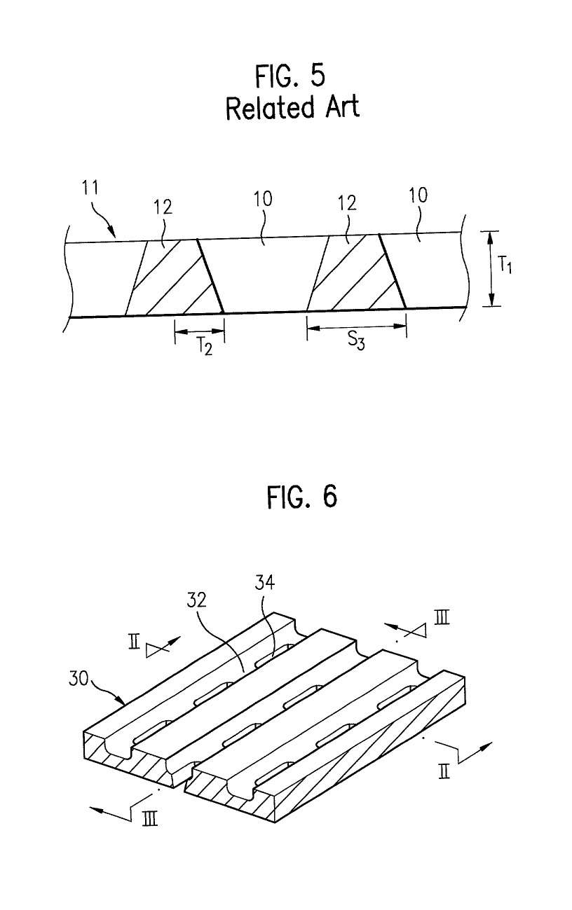

Reference will now be made in detail to the preferred embodiments of the present invention, examples of which are illustrated in the accompanying drawings. The preferred embodiment of the present invention will be explained with reference to FIGS. 6˜8. The mask has numerous electron beam pass through holes of a fixed pattern formed therein for selective pass through of the electron beams 9, with bridges connected to non-hole portions between the beam pass through holes in a width direction. As shown in FIG. 6, the mask 30 of the present invention is designed to have approx. 80 μm thickness, an allowable maximum range of tension thickness, for solving problems in the related art caused by the thin thickness.

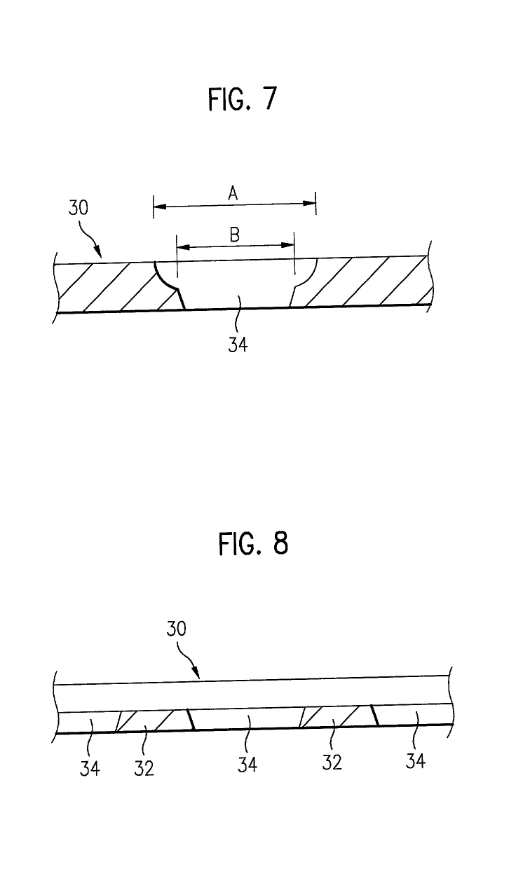

Moreover, the drop of actual transmissivity caused by the thicker thickness is solved as follows. A thickness of the mask 30 in the vicinity of the bridges 32, or in the vicinity of the beam pass through holes 34 inclusive of the bridges 32, is formed thinner relative to a thickness of portions of the mask 30 excluding the portions in the vicinity of the bridges 32, or in the vicinity of the beam pass through holes 34 inclusive of the bridges 32, for improving the beam transmissivity. Considering that the beam transmissivity decreases as the thicknesses of the beam pass through holes 34 and the bridges become the thicker, and increases as the thicknesses of the beam pass through holes 34 and the bridges become the thinner, the mask 30 of the present invention can have an increased beam transmissivity by reducing the thicknesses of the beam pass through holes 34 and the bridges 32. As shown in FIG. 7, a width ‘A’ of a thin portion in the mask 30 is designed to be larger than a width ‘B’ of the beam pass through hole, but smaller than 2×the width ‘B’ of the beampass through hole (B<A<2B). Because, if the width ‘A’ of the thin portion is smaller than the width ‘B’ of the beam pass through hole, an effect of the beam transmissivity enhancement is dropped, and opposite to this, if the width ‘A’ of the thin portion is greater than the width 2×‘B’ of the beam pass through hole, a tensile strength of the mask 30 is dropped. And, as shown in FIG. 8, a thickness ratio of the thicker portion to the thinner portion is required to have a relation of the thicker portion×⅛≦thin portion≦thick portion×6/8, because, if the thin portion is thinner than (the thick portion×⅛), the tensile strength of the mask is weak, and, opposite to this, if the thinner portion is thicker than (the thick portion×6/8), the beam transmissivity is dropped as the thickness increases. And, for forming the thickness of the mask 30 in the vicinity of the bridges 32, or in the vicinity of the beam pass through holes 34 inclusive of the bridges 32, thinner, either side, or both sides, of the mask 30 facing the electron gun 13 or/and the panel 1 in the vicinity of the bridges 32, or in the vicinity of the beam pass through holes 34 inclusive of the bridges 32, may be recessed. In view of advantages in fabrication, it is preferable that the side facing the electron gun 13 is recessed. The recess may be done by half etching mostly used in a thin film etching.

Thus, the mask in a color cathode ray tube of the present invention can reduce an amount of the electron beam cut off by the bridge 32 as areas of the bridges 32 with respect to an incident direction of the electron beams can be reduced by forming thicknesses of the mask 30 in the vicinity of the bridges 32, or in the vicinity of the beam pass through holes 34 inclusive of the bridges 32, thinner by half etching. Accordingly, vibration of the mask 30 can be attenuated as the mask 30 is kept thicker, and a luminance of the screen can be enhanced as an amount of transmission of the electron beams 9 through the beam pass through holes 34 can be increased in comparison to the mask with a thick fixed thickness.

As has been explained, the mask in a color cathode ray tube of the present invention has the following advantages.

The thick mask of the present invention can prevent, not only deformation of the mask during fabrication, but also howling because a size of vibration occurred by an external impact is not great even if the mask is fitted to the cathode ray tube.

The thick mask of the present invention permits washing to prevent clogging of the beam pass through holes by foreign matters since there is no fear of deformation, contrary to the thin mask in the related art.

A transmissivity almost similar to a related art mask with a 25 μm thickness can be maintained because a thickness around the beam pass through hole is formed thin by the half etching even if an overall thickness is great.

The reduction of requirement for rolling from three times to one or two times for making flat mask simplifies a fabrication process, and improves supply speed of a raw material as there is no possibility of deformation during transportation.

It will be apparent to those skilled in the art that various modifications and variations can be made in the mask in a color cathode ray tube of the present invention without departing from the spirit or scope of the invention. Thus, it is intended that the present invention cover the modifications and variations of this invention provided they come within the scope of the appended claims and their equivalents.

What is claimed is:

1. A mask in a color cathode ray tube, comprising electron beam pass through holes with bridges connected to non-hole portions between the beam pass through holes in a width direction, wherein a thickness of the bridge of the mask facing an electron gun is formed thinner than other portions of the mask.

2. A mask as claimed in claim 1, wherein a relation of a thicker portion to a thinner portion of the mask is the thicker portion×⅛≦thinner portion≦thicker portion×6/8.

3. A mask as claimed in claim 1, wherein a relation of a width ‘A’ of a thinner portion of the mask to a width ‘B’ of the beam pass through hole is B≦A≦2B.

4. A mask as claimed in claim 1, wherein a thickness of a portion in the vicinity of the beam pass through hole inclusive of the bridge is formed thinner than other portions.

5. A mask as claimed in claim 4, wherein the bridge or a portion in the vicinity of the beam pass through hole inclusive of the bridge is recessed by etching.

6. A mask as claimed in claim 4, wherein a relation of a thicker portion to a thinner portion of the mask is the thicker portion×⅛≦thinner portion≦thicker portion×6/8.

7. A mask as claimed in claim 4, wherein a relation of a width ‘A’ of a thinner portion of the mask to a width ‘B’ of the beam pass through hole is B≦A≦2B.

8. A mask as claimed in claim 1, wherein the mask has a thickness in a range of 25˜80 μm.
